(19) United States
(12) Patent Application Publication
(10) Pub. No.: US 2008/0171309 A1
(43) Pub. Date: Jul. 17, 2008

(54) Mathematical learning tables

(76) Inventor: Frank J. Volpe, Carlsbad, CA (US)

Correspondence Address: DON E. ERICKSON, STE. 104 #627, 7668 EL CAMINO REAL, LA COSTA, CA, 92009, US

(21) Appl. No.: 12/008,592

(22) Filed: Jan. 11, 2008

Related U.S. Application Data
(60) Provisional application No. 60/880,644, filed on Jan. 13, 2007.
(60) Provisional application No. 60/918,150, filed on Mar. 15, 2007.

(51) Int. Cl. G09B 19/02

(52) U.S. Cl. 434/198

(57) ABSTRACT

The present invention comprises a teaching aid for increasing the probability of learning the results of a mathematical operation consisting of a series of tables containing mathematical facts based on mathematical operations performed on a subset of whole numbers. Each successive table displays a decreasing subset of the mathematical facts, which encourages the student to learn said facts based on the mathematical operation involved.

### FIELD OF THE INVENTION

This invention pertains to the teaching of basic computational facts in mathematics to students, and more particularly to the increased probability of the student learning the basic facts of addition/subtraction and multiplication/division through methods of reward and methods of connecting mathematical relationships to reduce the number of facts to be learned.

### BACKGROUND OF THE INVENTION

This application is based on the provisional application filed Jan. 13, 2007 and assigned Appl. No. 60/880,644, entitled “Vanishing Tables,” and the provisional application filed Mar. 15, 2007 and assigned App. No. 60/918,150 entitled “Jumbled Tables.”

In the past, many attempts have been made to develop devices and methods for teaching basic mathematics facts such as multiplication tables to students of all ages. For example, flash cards having one-half of a multiplication equation on one side of the card and the other half, or the answer, on the reverse side have been used and have become a standard part of the curriculum of many schools. These devices employ primary visual sensory input, i.e. reading the equation and an oral response, i.e. reciting the answer. Exemplar of this method is U.S. Pat. No. 4,512,746.

Another system for teaching mathematics to beginning students includes a series of gloves and/or finger puppets, with the digits representing non-sequential number series (e.g., two, four, six, etc.). Students are taught to count various non-sequential number series using visual and tactile senses by using the gloves and/or finger puppets and associated hand patterns, with further audible reinforcement being provided by stories corresponding to each of the non-sequential series. Exemplar of this method us U.S. Pat. No. 6,155,836

Each of the foregoing teaching methods has drawbacks. They require learning facts without showing the commutative concepts. The prior art does not show the inverse relationship of the operations. There is no incentive for students to learn facts. The present invention overcomes these deficiencies by requiring the student to utilize motor reflexes to reinforce the learning process through employment of modified tables of mathematical facts.

### SUMMARY OF THE INVENTION

The present invention comprises a teaching aid for increasing the probability of learning the results of a mathematical operation comprising a first table having a grid system of vertical columns and horizontal rows wherein the first vertical column displays a subset of whole numbers, and the first horizontal row contains the same selected whole numbers, wherein the intersection of the first vertical column and the first horizontal row displays the mathematical operations involved, an operation and its inverse operation, and wherein the remainder of the grid displays the results of the mathematical operation between the corresponding whole numbers displayed in the first vertical column and the first horizontal row; and a second table having the grid system of the first table, but wherein only a selected portion of results of the mathematical operation between the corresponding whole numbers are displayed in the intersection of the vertical columns and horizontal rows. The teaching aid additional comprises a plurality of other tables each having the grid system of the first table, wherein the other tables consecutively display fewer results of the mathematical operation between the corresponding whole numbers than are displayed in the previous table.

### DRAWINGS

FIG. 1 is a plan view of the table of the first embodiment of the invention displaying a first mathematical operation to be performed and all elements of the table.

FIG. 2 is a plan view of the table of the invention displaying a selected subset of the elements of table 1.

FIG. 3 is a plan view of the table of the invention displaying a selected subset of the elements of table 2.

FIG. 4 is a plan view of the table of the first embodiment of the invention displaying second mathematical operation to be performed and all elements of the table.

FIG. 5 is a plan view of the table of the invention displaying a selected subset of the elements of table 4.

FIG. 6 is a plan view of the table of the invention displaying a selected subset of the elements of table 5.

FIG. 7 is a plan view of a table of the second embodiment of the invention displaying a mathematical operation to be performed and all elements of the table.

FIG. 8 is a plan view of the table of the invention displaying a selected subset of the elements of table 7

### DETAILED DESCRIPTION OF THE INVENTION

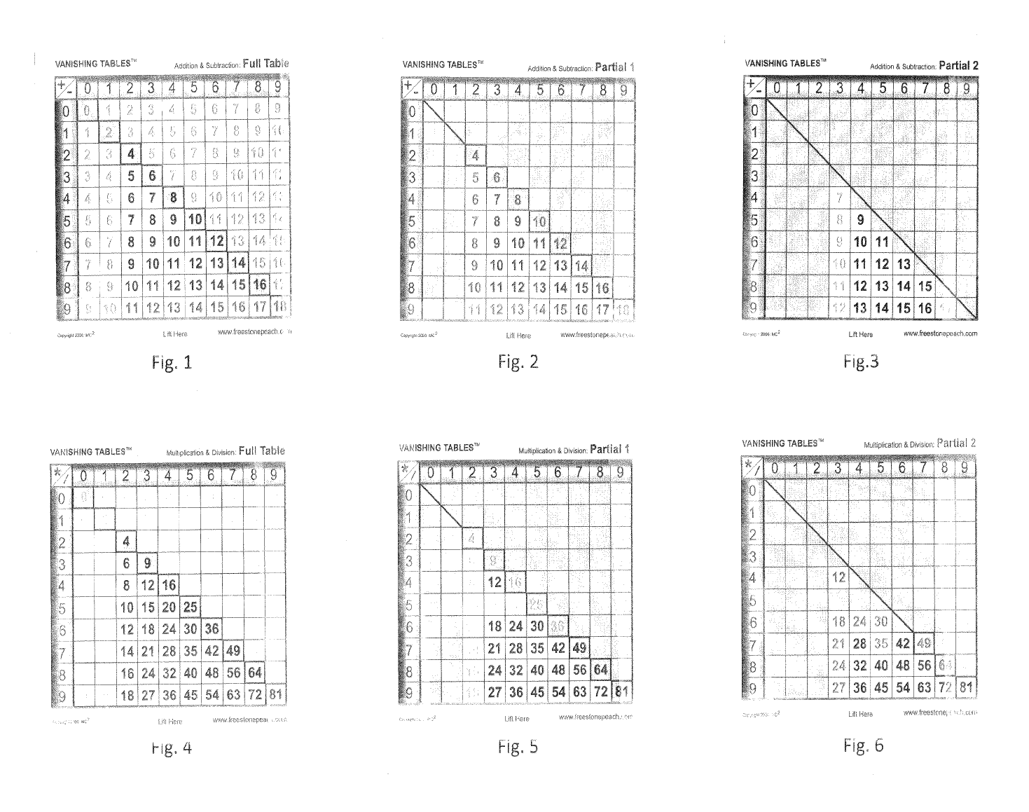

In the preferred embodiment of the invention, FIG. 1 displays a full table having a grid system of vertical columns and horizontal rows, where the first vertical column displays a subset of whole numbers, in numerical order from 0 through 9, and the first horizontal row contains the same selected whole numbers, in numerical order from 0 through 9. The intersection of the first vertical column and the first horizontal row displays the mathematical operations involved, in this case addition and its inverse function, subtraction. The remainder of the grid displays the results of the mathematical operations between the corresponding whole numbers displayed in the first vertical column and first horizontal row. For example, the intersection of 3 on the first horizontal column with 6 on the first vertical row results in the sum of 9. Correspondingly, for subtraction, one locates the horizontal row or vertical column for the minuend, follows the column to the subtrahend, and the difference is shown in the first column of corresponding vertical column or horizontal row. One of ordinary skill in the art would recognize that the numbers in the grid are symmetrical about the diagonal from the upper left corner to the bottom right corner of the table of FIG. 1, and the intersection along such diagonal is the double of each whole number, 0-9. It should be apparent from one of ordinary skill in the art that it is not a restriction of the invention that the results to be maintained from the table of FIG. 1 to the table of FIG. 2 be either above or below the diagonal of Table 1. It is only necessary that the student be able to determine the results of the mathematical function performed, and, if necessary, be able to reconstruct the full table from the table of FIG. 2

Referring again to the full table of FIG. 1, a selected subset of whole numbers on or below the diagonal are shown as bolded font, whereas the remainder of the whole number results are shown as shaded. These shaded whole numbers will be blanked from the table of FIG. 2, or will be shown to have “vanished” from the table of FIG. 2. In discussing these tables with the student, the teacher will advise the student that they may use the full table of FIG. 1 for a proscribed period of time, but that sometime, this table will be taken away and they will be given another table without the shaded results indicated by FIG. 2, so that the student had the incentive to learn the facts of table 1 before being restricted to the use of the table of FIG. 2, with its “vanished” facts.

Referring now to the table of FIG. 2, one can see that the whole numbers displayed are those that were in bolded font of the whole numbers of the table of FIG. 1, however the student will see that a further subset of whole numbers have been shown to be shaded, reflecting numbers the student should ensure are learned before the use of the table of FIG. 2 is proscribed.

Referring now to the table of FIG. 3, one can see that the whole numbers displayed are those that were in bolded font of the whole numbers of the table of FIG. 2, however the student will see that a further subset of whole numbers have been shown to be shaded, reflecting numbers the student should ensure are learned before the use of the next table.

One of ordinary skill in the art will readily understand that additional tables may be provided with successively decreasing number of results displayed on the table. One of ordinary skill in the art would recognize that the numbers in the grid are symmetrical about the diagonal from the upper left corner to the bottom right corner of the table of FIG. 1, and the intersection along such diagonal is the square of each whole number, 0-9. Again, it should be apparent from one of ordinary skill in the art that it is not a restriction of the invention that the results to be maintained from the table of FIG. 1 to the table of FIG. 2 be either above or below the diagonal of Table 1. It is only necessary that the student be able to determine the results of the mathematical operation performed, and, if necessary, be able to reconstruct the full table from the table of FIG. 2

Referring now to FIG. 4, it displays a full table having a grid system of vertical and horizontal columns, where the first vertical column displays a selected number of whole numbers, in numerical order from 0 through 9, and the first horizontal column contains the same selected whole numbers, in numerical order from 0 through 9. The intersection of the first vertical column and the first horizontal column displays the mathematical operations involved, in this case the multiplication and its inverse operation, division. The remainder of the grid displays the results of the mathematical operations between the corresponding whole numbers displayed in the first vertical column and first horizontal row. For example, the intersection of 3 on the vertical table with 6 on the horizontal table results in the product of 18. Correspondingly, for division, one locates divisor on the first vertical column, follows the row to the dividend, and the quotient is shown in the first horizontal column. It should be noted that since the table of FIG. 4 is symmetrical, one may find the divisor on either the vertical column or horizontal row and follow the same procedure to find the quotient.

Referring again to the table of FIG. 4, a selected subset of whole numbers below the diagonal are shown as bolded font, whereas the remainder of the whole number results are shown as shaded. These shaded numbers will be removed from the table of FIG. 5, or will be shown to have “vanished” from the table of FIG. 5. In discussing these tables with the student, the teacher will advise the student that they may use the full table of FIG. 4 for a proscribed period of time, but that sometime, they will only be able to use the table of FIG. 5, so that the student has the incentive to learn the facts of the table of FIG. 4 before being restricted to the use of the table of FIG. 5, with its “vanished” facts.

Referring now to the table of FIG. 5, one can see that the whole numbers displayed are those that were in bolded font of the whole numbers of the table of FIG. 4, however the student will see that a further subset of whole numbers have been shown to be shaded, reflecting numbers the student should ensure are memorized before the use of the table of FIG. 5 is proscribed.

Referring now to the table of FIG. 6, one can see that the whole numbers displayed are those that were in bolded font of the whole numbers of the FIG. 5, however the student will see that a further subset of whole numbers have been shown to be shaded, reflecting numbers the student should ensure are learned before the use of the next table.

One of ordinary skill in the art will readily understand that additional tables may be provided with successively decreasing number of results displayed on the table.

In application the teacher is provided a set of pads of tables, each pad consisting of a multiplicity of pages. The teacher initially hands out the full table, i.e., the table of FIG. 1 or FIG. 4 (depending on which facts are to be learned) to each student. The student is advised that the student may use the full table for a selected period for problem solving and tests. After the selected period, the full table will be collected, and a second table distributed, that table being similar to the table of FIG. 2 or FIG. 5, having blanked spaces where indicated as shaded on the full table. The knowledge that the full table will be withdrawn provides the incentive for the student to learn the results shown on the full table, and to understand the mathematical function and symmetry of the full table. The student is allowed to use the second table for a second selected period before the second table is withdrawn, and the third table distributed. In the preferred embodiment, there may be five or six total pads, each showing a declining number of results on successive tables. One of ordinary skill in the art would readily recognize that the invention is not limited to a 10 by 10 grid. The number of whole numbers on which to be operated is entirely a function of the education level of the student and the complexity of the mathematical operation being taught.

It should be noted that even for colorblind students, colors are very useful cues to distinguish different objects easily and quickly. By carefully selecting colors that are easily recognizable to people with all kinds of color vision, one can maximize the effect of the presentation of the tables to all students. Therefore, the shaded whole numbers selected for removal from the succeeding table may be colored optimize the ability of the colorblind student to discern the numbers. In the present invention, the color orange has been found to be optimal.

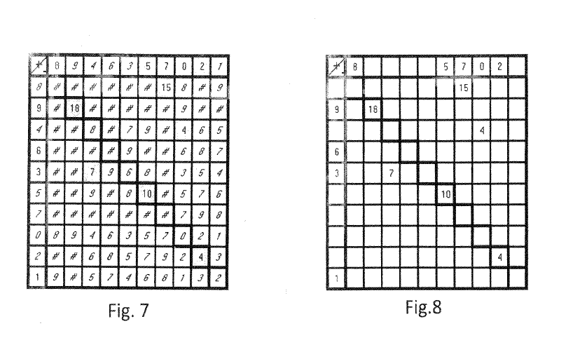

In a second embodiment of the invention, FIG. 7 displays a table having a grid system of vertical columns and horizontal rows, where the first vertical column displays a subset of whole numbers, from 0 through 9, in random order, and the first horizontal row contains the same subset of whole numbers, from 0 through 9, in a different random order. The intersection of the first vertical column and the first horizontal column displays the mathematical operations involved, in this case the inverse functions of addition and subtraction, but a similar table for the inverse operations multiplication and division with appropriate results in the body of the table can be used. The remainder of the grid displays the results of the mathematical operations between the corresponding whole numbers displayed in the vertical and horizontal columns. This table 7 serves as a guide for both the teacher and the student. In this embodiment, a second table, as shown in FIG. 8, is distributed to the student, wherein a selected number of whole numbers from the first vertical column, and a selected number of whole numbers from the first horizontal row of the table of FIG. 7 have been blanked. Concomitantly, a selected number of the results have also been blanked. The student is then required to fill in the missing results based on the inverse mathematical operations for the respective table.

While the present description contains much specificity, this should not be construed as limitations on the scope of the invention, but rather as examples of some preferred embodiments thereof. Accordingly, the scope of the invention should not be determined by the specific embodiments illustrated herein. The full scope of the invention is further illustrated by the claims appended hereto.

1. A teaching aid for increasing the probability of learning the results of a mathematical operation comprising:
(a) A first table having a grid system of vertical columns and horizontal rows wherein the first vertical column displays a subset of whole numbers, and the first horizontal row contains the same subset of whole numbers, wherein the intersection of the first vertical column and the first horizontal row displays the mathematical operations involved, and wherein the remainder of the grid displays the results of the mathematical operation involved between the corresponding whole numbers displayed in the vertical and horizontal columns; and
(b) A second table having the grid system of the first table, but wherein only a selected portion of results of the mathematical operations between the corresponding whole numbers are in the vertical columns and horizontal rows are displayed and the remaining results are blanked.

2. The teaching aid of claim 1 wherein the mathematical operation to be performed comprises inverse mathematical functions.

3. The teaching aid of claim 2 wherein the inverse functions are addition and subtraction.

4. The teaching aid of claim 2 wherein the inverse functions are multiplication and division.

5. The teaching aid of claim 1 wherein the whole numbers in the first vertical column and the first horizontal row range from 0 through 9 in numerical order.

6. The teaching aid of claim 1 wherein the results blanked on the second table are displayed as shaded on the first table.

7. The teaching aid of claim 1 wherein the results displayed as shaded in the first table are displayed in a selected color.

8. The teaching aid of claim 1 wherein a selected portion of the results displayed on the second table are shaded.

9. The teaching aid of claim 8 wherein the results displayed as shaded in the second table are displayed in a selected color.

10. The teaching aid of claim 1 additionally comprising a third table having the grid system of the first table, wherein the third table displays fewer results of the mathematical operation between the corresponding whole numbers than are displayed in the second table.

11. The teaching aid of claim 10 wherein a selected portion of the results displayed on the third table are shaded.

12. The teaching aid of claim 8 wherein the results displayed as shaded in the second table are displayed in a selected color.

13. A teaching aid for increasing the probability of learning the results of a mathematical operation comprising:
(a) A first table having a grid system of vertical columns and horizontal rows wherein the first vertical column displays a subset of whole numbers, and the first horizontal displays the same subset of whole numbers, wherein the intersection of the first vertical column and the first horizontal row displays inverse mathematical operations performed, and wherein the remainder of the grid displays the results of the inverse mathematical operations between the corresponding whole numbers displayed in the vertical columns and horizontal rows;
(b) wherein the whole numbers in the first vertical column and the first horizontal column of the first table range from 0 through 9, in numerical order; and
(c) a second table having the grid system of the first table, but wherein only a selected portion of results of the inverse mathematical operations between the corresponding whole numbers in the vertical columns and horizontal rows are displayed and the remaining results are blanked; and
(d) a third table having the grid system of the first table, wherein the third table displays fewer results of the mathematical operation between the corresponding whole numbers than are displayed in the second table.

14. The teaching aid of claim 13 wherein the inverse mathematical functions are addition and subtraction.

15. The teaching aid of claim 13 wherein the inverse mathematical functions are multiplication and division.

16. The teaching aid of claim 13 wherein the results blanked on the second table are displayed as shaded on the first table.

17. The teaching aid of claim 13 wherein a selected portion of the results displayed on the second table are shaded

18. The teaching aid of claim 13 wherein a selected portion of the results displayed on the third table are shaded.

19. A teaching aid for increasing the probability of learning the results of a mathematical operation comprising:
(a) A first table having a grid system of vertical columns and horizontal rows wherein the first vertical column displays a subset of whole numbers in random order, and the first horizontal row contains the same subset of whole numbers in a different random order than that of the first vertical column, wherein the intersection of the first vertical column and the first horizontal row displays the inverse mathematical operations performed, and wherein the remainder of the grid displays the results of the inverse mathematical operations performed between the corresponding whole numbers displayed in the vertical columns and horizontal rows; and
(b) A second table having the grid system of the first table, but wherein only a selected portion of the whole numbers of the first vertical column are displayed and a selected portion of the first horizontal row are displayed, and wherein only a selected portion of the results of the mathematical operations between the corresponding whole numbers in the vertical columns and horizontal rows are displayed and the remaining results are blanked.

20. The teaching aid of claim 19 wherein the inverse mathematical functions are addition and subtraction.

21. The teaching aid of claim 19 wherein the inverse mathematical functions are multiplication and division.
